(19) United States
(12) Patent Application Publication
(10) Pub. No.: US 2012/0270124 A1
(43) Pub. Date: Oct. 25, 2012

(54) FUEL CELL SYSTEM AND OPERATING METHOD FOR FUEL CELL SYSTEM

(75) Inventors: Takatoshi Masui, Mishima-shi (JP); Takashi Shigehisa, Kirishima-shi (JP)

(73) Assignees: KYOCERA CORPORATION, Kyoto (JP); TOYOTA JIDOSHA KABUSHIKI KAISHA, Toyota-shi (JP)

(21) Appl. No.: 13/391,091

(22) PCT Filed: Aug. 19, 2010
(86) PCT No.: PCT/IB10/02239

§ 371 Date: Jul. 12, 2012

(30) Foreign Application Priority Data
Aug. 20, 2009 (JP) 2009-190641

(51) Int. Cl. H01M 8/04; H01M 8/06

(52) U.S. Cl. 429/425; 429/431

(57) ABSTRACT

A fuel cell system includes: a fuel cell that generates power using an oxidant gas and a fuel gas; estimating means for estimating an electric resistance of the fuel cell in accordance with a voltage and a current of the fuel cell; and temperature controlling means for performing control to raise a temperature of the fuel cell when the electric resistance estimated by the estimating means exceeds a target electric resistance range and reduce the temperature of the fuel cell when the estimated electric resistance falls below the target electric resistance range.

### BACKGROUND OF THE INVENTION

1. Field of the Invention

The invention relates to a fuel cell system including a fuel cell, and an operating method for the fuel cell system.

2. Description of the Related Art

A fuel cell system including a fuel cell is typically a system that obtains electric energy using hydrogen and oxygen as fuel. This type of fuel cell system is superior in terms of environmental friendliness and capable of realizing high energy efficiency, and is therefore being widely developed as an energy supply system of the future.

For example, a high temperature operation type fuel cell such as a solid oxide fuel cell (SOFC) generates power using a fuel gas that contains hydrogen obtained by reforming a hydrocarbon based fuel. The operating temperature of an SOFC is approximately 600° C. to 1000° C., for example.

In consideration of the thermal efficiency, durability life, and so on of a fuel cell that operates at a high temperature such as an SOFC, the temperature of the fuel cell is preferably controlled precisely to remain within a target temperature range. To control the temperature of the fuel cell, the temperature of the fuel cell must be detected. Hence, Japanese Patent Application Publication No. 2005-332652 (JP-A-2005-332652) discloses a technique for estimating the temperature of a fuel cell in accordance with a fuel gas flow rate, an oxidant gas flow rate, and an output power of the fuel cell.

According to this technique, however, flow meters for measuring the flow rates of the fuel gas and the oxidant gas are expensive, leading to an increase in the overall cost of the fuel cell system. Therefore, a method of detecting the temperature of the fuel cell using a temperature sensor may be considered. However, when a thermistor is used as the temperature sensor, a high degree of responsiveness cannot be obtained. Further, when a thermocouple is used as the temperature sensor, the durability of the thermocouple is low, and a device such as an amplifier is also required.

### SUMMARY OF INVENTION

The invention provides a fuel cell system and an operating method for the fuel cell system with which a temperature of a fuel cell can be controlled without using a temperature sensor.

A first aspect of the invention relates to a fuel cell system including: a fuel cell that generates power using an oxidant gas and a fuel gas; estimating means for estimating an electric resistance of the fuel cell in accordance with a voltage and a current output by the fuel cell; and temperature controlling means for performing temperature control to raise a temperature of the fuel cell when the electric resistance estimated by the estimating means exceeds a target electric resistance range and reduce the temperature of the fuel cell when the estimated electric resistance falls below the target electric resistance range. According to this constitution, the electric resistance, which has a correlative relationship with the temperature of the fuel cell, can be estimated on the basis of the voltage and current of the fuel cell. Therefore, the temperature of the fuel cell can be controlled easily without using a temperature sensor.

In the fuel cell system according to this aspect, the temperature control may be control for raising the temperature of the fuel cell by a steadily greater amount as a difference between the estimated electric resistance and an upper limit of the target electric resistance range increases and reducing the temperature of the fuel cell by a steadily greater amount as a difference between the estimated electric resistance and a lower limit of the target electric resistance range increases.

In the fuel cell system according to this aspect, the temperature control means may vary the temperature of the fuel cell by a steadily greater amount as the current that is output by the fuel cell increases. In the fuel cell system according to this aspect, the estimating means may estimate the electric resistance in accordance with an incline of a current-voltage characteristic that the fuel cell has, on the basis of a value of the voltage relative to the current output by the fuel cell or a value of the current relative to the voltage output by the fuel cell, or on the basis of an open circuit voltage value that the fuel cell has or a value determined using the open circuit voltage.

In the fuel cell system according to this aspect, the temperature controlling means may vary the temperature of the fuel cell by increasing or decreasing a supply amount of the oxidant gas supplied to the fuel cell, by increasing or decreasing a power generation amount of the fuel cell, or by increasing or decreasing a supply amount of the fuel gas supplied to the fuel cell.

The fuel cell system according to this aspect may further include a reformer for generating the fuel gas from a hydrocarbon based fuel and supplying the fuel gas to the fuel cell, wherein the temperature controlling means may vary the temperature of the fuel cell by increasing or decreasing a supply amount of the hydrocarbon based fuel supplied to the reformer, and the fuel gas may contain hydrogen.

The fuel cell system according to this aspect may further include setting means for setting the target electric resistance range, wherein the setting means may set the target electric resistance range at a steadily higher value as the current of the fuel cell decreases. In the fuel cell system according to this aspect, the fuel cell may be an SOFC.

A second aspect of the invention relates to an operating method for a fuel cell system, including: estimating an electric resistance of a fuel cell in accordance with a voltage and a current output by the fuel cell; and performing temperature control to raise a temperature of the fuel cell when the estimated electric resistance exceeds a target electric resistance range and reduce the temperature of the fuel cell when the estimated electric resistance falls below the target electric resistance range. According to this constitution, the electric resistance, which has a correlative relationship with the temperature of the fuel cell, can be estimated on the basis of the voltage and current of the fuel cell. Therefore, the temperature of the fuel cell can be controlled easily without using a temperature sensor.

In the operating method according to this aspect, the temperature control may be control for raising the temperature of the fuel cell by a steadily greater amount as a difference between the estimated electric resistance and an upper limit of the target electric resistance range increases and reducing the temperature of the fuel cell by a steadily greater amount as a difference between the estimated electric resistance and a lower limit of the target electric resistance range increases.

In the operating method according to this aspect, the temperature control may be control for varying the temperature of the fuel cell by a steadily greater amount as the current that is output by the fuel cell increases. In the operating method according to this aspect, the electric resistance may be estimated in accordance with an incline of a current-voltage characteristic that the fuel cell has, on the basis of a value of the voltage relative to the current output by the fuel cell or a value of the current relative to the voltage output by the fuel cell, or on the basis of an open circuit voltage value that the fuel cell has or a value determined using the open circuit voltage.

In the operating method according to this aspect, the temperature control may be control for varying the temperature of the fuel cell by increasing or decreasing a supply amount of an oxidant gas supplied to the fuel cell, by increasing or decreasing a power generation amount of the fuel cell, or by increasing or decreasing a supply amount of a fuel gas supplied to the fuel cell.

In the operating method according to this aspect, the temperature control may be control for varying the temperature of the fuel cell by increasing or decreasing a supply amount of a hydrocarbon based fuel that is supplied to a reformer for generating a fuel gas containing hydrogen from the hydrocarbon based fuel and supplying the fuel gas to the fuel cell. The operating method according to this aspect may further include setting the target electric resistance range at a steadily higher value as the current of the fuel cell decreases. In the operating method according to this aspect, the fuel cell may be an SOFC.

According to the invention, a fuel cell system and an operating method for the fuel cell system with which a temperature of a fuel cell can be controlled without using a temperature sensor can be provided.

### BRIEF DESCRIPTION OF DRAWINGS

The foregoing and further objects, features and advantages of the invention will become apparent from the following description of example embodiments with reference to the accompanying drawings, wherein like numerals are used to represent like elements and wherein:

FIG. 1 is a schematic diagram showing the overall constitution of a fuel cell system according to a first embodiment of the invention;

FIG. 2 is a view illustrating a relationship between a temperature and an electric resistance of a fuel cell;

FIG. 3 is a view showing an example of a flowchart executed to control the temperature of the fuel cell during power generation;

FIG. 4 is a view showing another example of a flowchart executed to control the temperature of the fuel cell during power generation;

FIG. 5 is a view showing a further example of a flowchart executed to control the temperature of the fuel cell during power generation;

FIG. 6 is a view illustrating a relationship between the temperature of the fuel cell and an open circuit voltage OCV;

FIG. 7A is a perspective view showing a fuel cell stack device and an oxidant gas introduction member according to a second embodiment, and FIG. 7B is a perspective view showing the constitution of the oxidant gas introduction member;

FIG. 8 is a partial perspective view including a cross-section of a fuel cell unit;

FIGS. 9A and 9B are views illustrating a temperature distribution in a fuel cell stack; and

FIG. 10 is a view illustrating positions of voltmeters.

### DETAILED DESCRIPTION OF EMBODIMENTS

Embodiments of the invention will be described below.

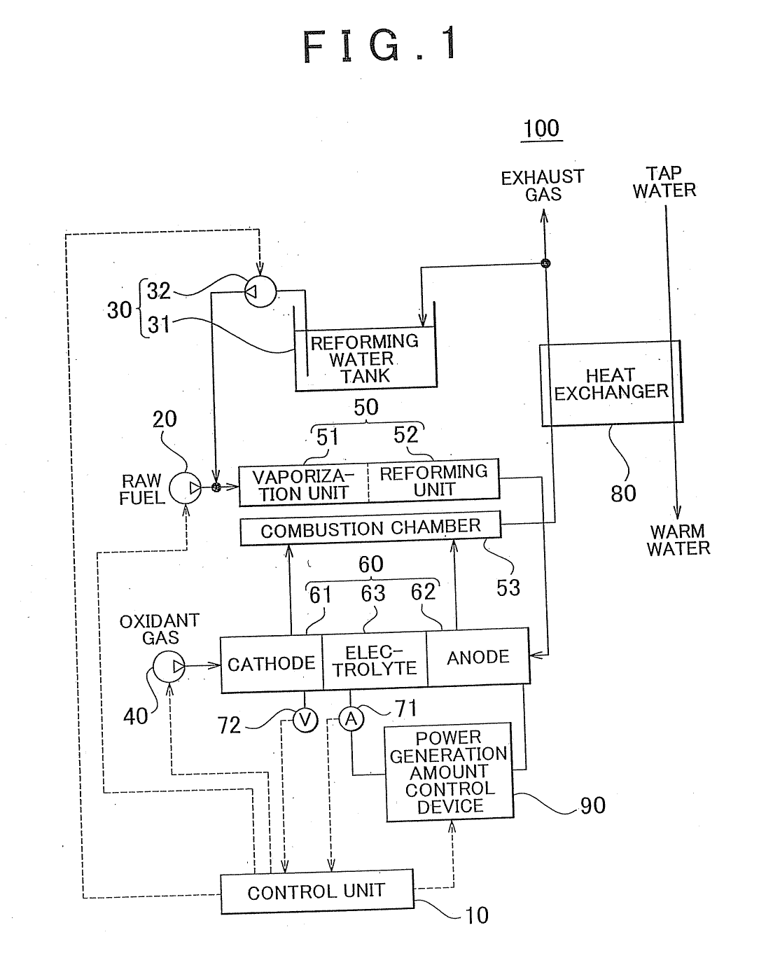

FIG. 1 is a schematic diagram showing the overall constitution of a fuel cell system 100 according to a first embodiment of the invention. As shown in FIG. 1, the fuel cell system 100 includes a control unit 10, a raw fuel supply unit 20, a reforming water supply unit 30, an oxidant gas supply unit 40, a reformer 50, a fuel cell 60, an ammeter 71, a voltmeter 72, a heat exchanger 80, and a power generation amount control device 90.

The control unit 10 is constituted by a Central Processing Unit (CPU), a Read-Only Memory (ROM), a Random Access Memory (RAM), and so on. The raw fuel supply unit 20 includes a fuel pump or the like for supplying raw fuel such as hydrocarbon to the reformer 50. The reforming water supply unit 30 includes a reforming water tank 31 for storing reforming water required in a steam reforming reaction in the reformer 50, a reforming water pump 32 for supplying the reforming water stored in the reforming water tank 31 to the reformer 50, and so on.

The oxidant gas supply unit 40 includes an air pump or the like for supplying an oxidant gas such as air to a cathode 61 of the fuel cell 60. The reformer 50 includes a vaporization unit 51 for vaporizing the reforming water and a reforming unit 52 for generating a fuel gas through a steam reforming reaction. The fuel cell 60 is a fuel cell having a structure in which an electrolyte 63 is sandwiched between the cathode 61 and an anode 62. The ammeter 71 is an ammeter for detecting a current generated by the fuel cell 60. The voltmeter 72 is a voltmeter for detecting a voltage between the cathode and the anode of the fuel cell 60. The power generation amount control device 90 is a device for controlling a power generation amount of the fuel cell 60. The power generation amount control device 90 is a power conditioner, for example.

Next, an outline of an operation of the fuel cell system 100 will be described. The raw fuel supply unit 20 supplies a required amount of fuel gas to the reformer 50 in accordance with an instruction from the control unit 10. The reforming water pump 32 supplies a required amount of reforming water to the reformer 50 in accordance with an instruction from the control unit 10. The reforming unit 52 of the reformer 50 generates a fuel gas containing hydrogen from the fuel gas and the reforming water by means of a reforming reaction using heat generated by a combustion chamber 53. The generated fuel gas is supplied to the anode 62 of the fuel cell 60.

The oxidant gas supply unit 40 supplies a required amount of oxidant gas to the cathode 61 of the fuel cell 60 in accordance with an instruction from the control unit 10. As a result, power generation is performed in the fuel cell 60. An oxidant off gas discharged from the cathode 61 and a fuel off gas discharged from the anode 62 flow into the combustion chamber 53. In the combustion chamber 53, the fuel off gas is burned by oxygen in the oxidant off gas. Heat obtained from the combustion is applied to the reformer 50 and the fuel cell 60. Hence, in the fuel cell system 100, combustible components such as hydrogen and carbon monoxide contained in the fuel off gas can be burned in the combustion chamber 53.

The heat exchanger 80 performs heat exchange between an exhaust gas discharged from the combustion chamber 53 and tap water flowing through the heat exchanger 80. Condensed water obtained from the exhaust gas as a result of the heat exchange is stored in the reforming water tank 31. The ammeter 71 detects the current output by the fuel cell 60 and provides the control unit 10 with the result. The voltmeter 72 detects the voltage of the fuel cell 60 and provides the control unit 10 with the result. The power generation amount control device 90 increases or decreases a power generation amount of the fuel cell 60 in accordance with an instruction from the control unit 10. The control unit 10 controls at least one of the raw fuel supply unit 20, the reforming water supply unit 30, the oxidant gas supply unit 40, and the power generation amount control device 90 in accordance with the results from the ammeter 71 and the voltmeter 72.

In this embodiment, temperature control is performed on the fuel cell 60 without using a temperature sensor. Factors determining the temperature of the fuel cell 60 will now be described. As factors that determine the temperature of the fuel cell 60, (i) heat generated due to electric resistance loss in the fuel cell 60, (ii) heat absorbed by internal reforming in the fuel cell 60, and (iii) heat exchange caused by radiation with peripheral devices such as the combustion chamber 53 may be cited. Note that internal reforming is a reforming reaction caused by hydrocarbon not used in the reforming reaction of the reforming unit 52 or the like via a catalyst of the anode 62.

Factor (i) is proportionate to a square of the current of the fuel cell 60 and therefore has a greater effect on the temperature of the fuel cell 60 than the other factors. Accordingly, the temperature of the fuel cell 60 can be estimated by detecting an electric resistivity of the fuel cell 60.

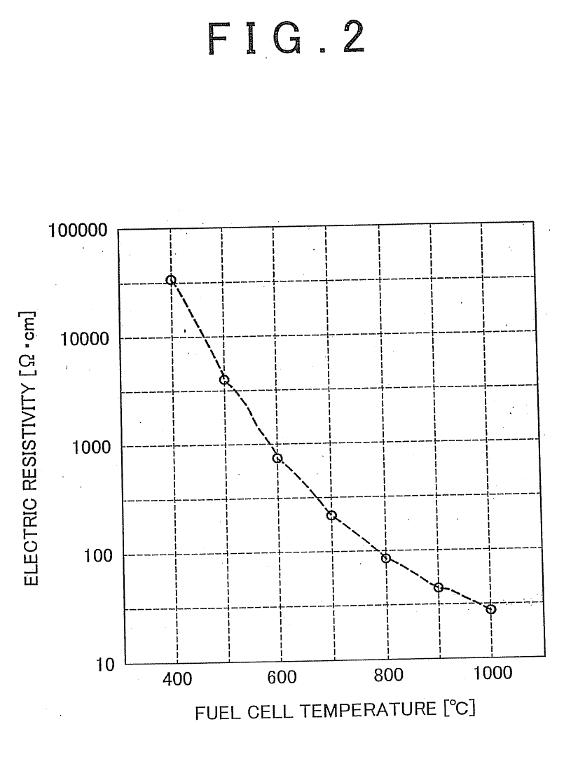

FIG. 2 is a view illustrating a relationship between the temperature and the electric resistivity of the fuel cell 60. In FIG. 2, the abscissa shows the temperature of the fuel cell 60 and the ordinate shows the electric resistivity. Further, in this embodiment, yttria-stabilized zirconia (YSZ) is used as the electrolyte of the fuel cell 60, but the electrolute applied to the invention is not limited to YSZ.

As shown in FIG. 2, the electric resistivity of the fuel cell 60 decreases as the temperature thereof increases. The reason for this is that the resistance of the electrolyte decreases as the temperature increases. Hence, by obtaining the electric resistivity, the temperature of the fuel cell 60 can be estimated. Therefore, in this embodiment, the temperature of the fuel cell 60 is controlled on the basis of the relationship shown in FIG. 2.

For example, the temperature of the fuel cell 60 can be controlled to a predetermined range by performing control to increase the temperature of the fuel cell 60 when the electric resistance of the fuel cell 60 exceeds a target electric resistance range and performing control to reduce the temperature of the fuel cell 60 when the electric resistance falls below the target electric resistance range. The electric resistance varies greatly in accordance with temperature variation in the fuel cell 60, and therefore temperature variation in the fuel cell 60 can be estimated with a high degree of precision by obtaining the electric resistance. Note that the target electric resistance range may have a predetermined width. Alternatively, a target electric resistance may be set at a single value.

Specifically, when an open circuit voltage of the fuel cell 60 is OCV (V), a momentary voltage at an arbitrary timing during power generation in the fuel cell 60 is V_t, and a momentary current at a timing that may be considered equivalent to the V_t detection timing during power generation in the fuel cell 60 is I_t, an estimated electric resistance R (Ω) of the fuel cell 60 can be expressed as shown in the following Equation (1).

R=(OCV−V_{—}t)/I_{—}t (1)

The open circuit voltage OCV is a voltage detected by the voltmeter 72 when a power generation current of the fuel cell 60 is zero. The momentary voltage V_t is a voltage detected by the voltmeter 72 when power generation is underway in the fuel cell 60. The momentary current I_t is a current detected by the ammeter 71 when power generation is underway in the fuel cell 60.

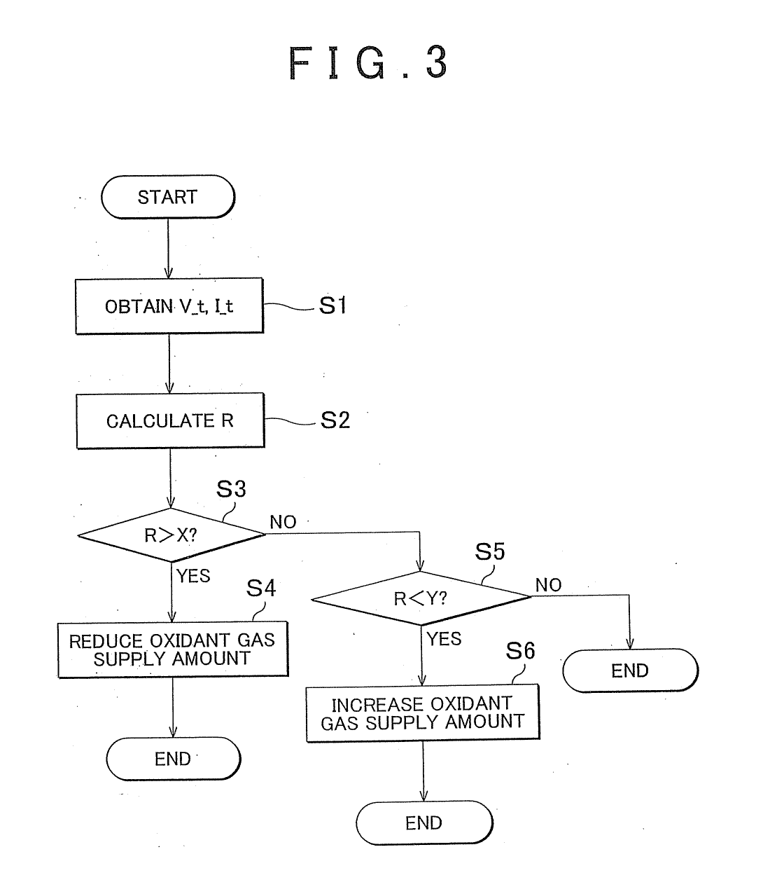

FIG. 3 is a view showing an example of a flowchart executed to control the temperature of the fuel cell 60 during power generation. Note that the flowchart shown in FIG. 3 is executed repeatedly at period intervals. Further, the flowchart in FIG. 3 illustrates a case in which the target electric resistance range has a predetermined width. As shown in FIG. 3, the control unit 10 obtains the momentary current I_t from the ammeter 71 and obtains the momentary voltage V_t from the voltmeter 72 (step S1). Next, the control unit 10 calculates the estimated electric resistance R on the basis of Equation (1) (step S2).

Next, the control unit 10 determines whether or not the estimated electric resistance R exceeds a first threshold X (step S3). The first threshold X is an upper limit value of the target electric resistance range, for example. When it is determined in step S3 that the estimated electric resistance R exceeds the first threshold X, the control unit 10 controls the oxidant gas supply unit 40 to reduce the amount of oxidant gas supplied to the cathode 61 (step S4). In this case, cooling of the fuel cell 60 by the oxidant gas is suppressed, and therefore the temperature of the fuel cell 60 can be increased. The control unit 10 then terminates execution of the flowchart.

When it is not determined in step S3 that the estimated electric resistance R exceeds the first threshold X, the control unit 10 determines whether or nor the estimated electric resistance R is smaller than a second threshold Y (<first threshold X) (step S5). The second threshold Y is a lower limit value of the target electric resistance range, for example. When it is determined in step S5 that the estimated electric resistance R is smaller than the second threshold Y, the control unit 10 controls the oxidant gas supply unit 40 to increase the amount of oxidant gas supplied to the cathode 61 (step S6). In this case, cooling of the fuel cell 60 is promoted, and therefore the temperature of the fuel cell 60 can be reduced. The control unit 10 then terminates execution of the flowchart.

According to the flowchart shown in FIG. 3, the temperature of the fuel cell 60 can be estimated in accordance with the estimated electric resistance R. Further, by increasing or reducing the amount of supplied oxidant gas such that the estimated electric resistance R enters a predetermined range, the temperature of the fuel cell 60 can be controlled to a predetermined range. Note that in step S4, the control unit 10 may control the oxidant gas supply unit 40 such that the amount of supplied oxidant gas is reduced by a steadily greater amount as a difference between the estimated electric resistance R and the first threshold X increases. Further, in step S6, the control unit 10 may control the oxidant gas supply unit 40 such that the amount of supplied oxidant gas is increased by a steadily greater amount as a difference between the estimated electric resistance R and the second threshold Y increases. In this case, the time required to control the temperature of the fuel cell 60 can be shortened.

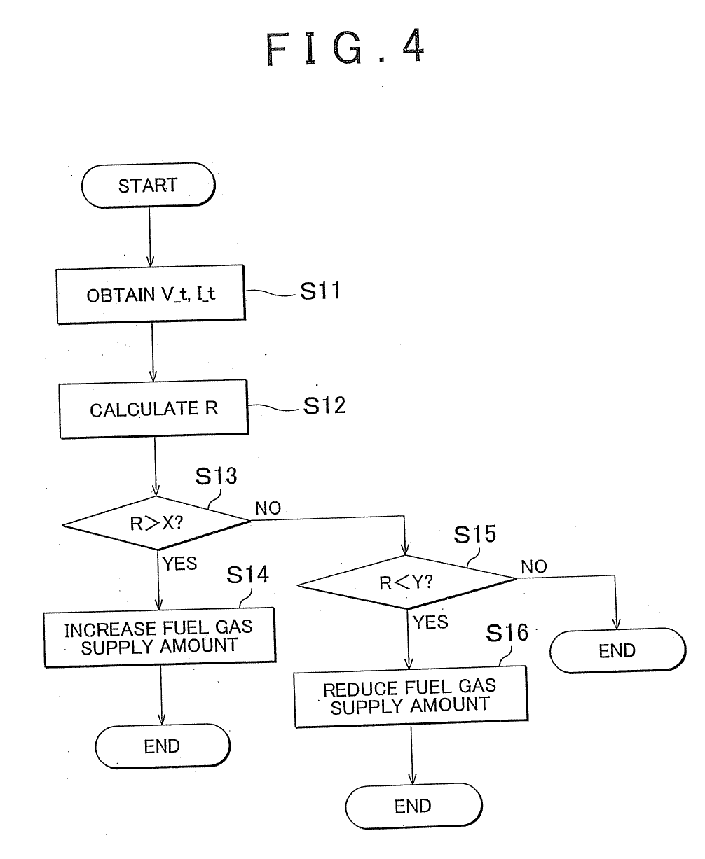

FIG. 4 is a view showing another example of a flowchart executed to control the temperature of the fuel cell 60 during power generation. Note that the flowchart shown in FIG. 4 is executed at period intervals. Further, the flowchart in FIG. 4 illustrates a case in which the target electric resistance range has a predetermined width. As shown in FIG. 4, the control unit 10 obtains the momentary current I_t from the ammeter 71 and obtains the momentary voltage V_t from the voltmeter 72 (step S11). Next, the control unit 10 calculates the estimated electric resistance R on the basis of Equation (1) (step S12).

Next, the control unit 10 determines whether or not the estimated electric resistance R exceeds the first threshold X (step S13). When it is determined in step S13 that the estimated electric resistance R exceeds the first threshold X, the control unit 10 controls the raw fuel supply unit 20 to increase the amount of raw fuel supplied to the reformer 50 (step S14). In this case, the amount of hydrogen contained in the fuel off gas increases, leading to an increase in the amount of combustion heat generated in the combustion chamber 53. Therefore the temperature of the fuel cell 60 can be increased. The control unit 10 then terminates execution of the flowchart.

When it is not determined in step S13 that the estimated electric resistance R exceeds the first threshold X, the control unit 10 determines whether or nor the estimated electric resistance R is smaller than the second threshold Y (<first threshold X) (step S15). When it is determined in step S15 that the estimated electric resistance R is smaller than the second threshold Y, the control unit 10 controls the raw fuel supply unit 20 to reduce the amount of raw fuel supplied to the reformer 50 (step S16). In this case, the amount of hydrogen contained in the fuel off gas decreases, leading to a reduction in the amount of combustion heat generated in the combustion chamber 53. Therefore the temperature of the fuel cell 60 can be reduced. The control unit 10 then terminates execution of the flowchart.

According to the flowchart shown in FIG. 4, the temperature of the fuel cell 60 can be estimated in accordance with the estimated electric resistance R. Further, by increasing or reducing the amount of supplied fuel gas such that the estimated electric resistance R enters a predetermined range, the temperature of the fuel cell 60 can be controlled to a predetermined range. Note that in step S14, the control unit 10 may control the raw fuel supply unit 20 such that the amount of supplied fuel gas is increased by a steadily greater amount as the difference between the estimated electric resistance R and the first threshold X increases. Further, in step S16, the control unit 10 may control the raw fuel supply unit 20 such that the amount of supplied fuel gas is reduced by a steadily greater amount as the difference between the estimated electric resistance R and the second threshold Y increases. In this case, the time required to control the temperature of the fuel cell 60 can be shortened.

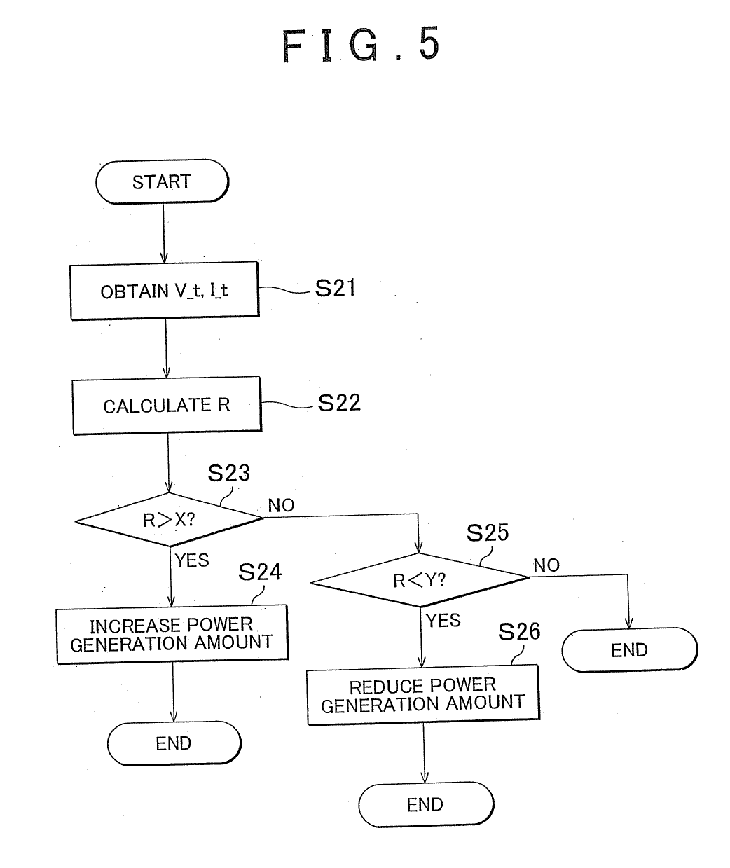

FIG. 5 is a view showing a further example of a flowchart executed to control the temperature of the fuel cell 60 during power generation. Note that the flowchart shown in FIG. 5 is executed at period intervals. Further, the flowchart in FIG. 5 illustrates a case in which the target electric resistance range has a predetermined width. As shown in FIG. 5, the control unit 10 obtains the momentary current I_t from the ammeter 71 and obtains the momentary voltage V_t from the voltmeter 72 (step S21). Next, the control unit 10 calculates the estimated electric resistance R on the basis of Equation (1) (step S22).

Next, the control unit 10 determines whether or not the estimated electric resistance R exceeds the first threshold X (step S23). When it is determined in step S23 that the estimated electric resistance R exceeds the first threshold X, the control unit 10 controls the power generation amount control device 90 to increase the power generation amount of the fuel cell 60 (step S24). In this case, the power generation amount (for example, the output current amount) of the fuel cell 60 increases, and therefore the temperature of the fuel cell 60 can be increased. The control unit 10 then terminates execution of the flowchart.

When it is not determined in step S23 that the estimated electric resistance R exceeds the first threshold X, the control unit 10 determines whether or nor the estimated electric resistance R is smaller than the second threshold Y (<first threshold X) (step S25). When it is determined in step S25 that the estimated electric resistance R is smaller than the second threshold Y, the control unit 10 controls the power generation amount control device 90 to reduce the power generation amount of the fuel cell 60 (step S26). In this case, the power generation amount (for example, the output current amount) of the fuel cell 60 decreases, and therefore the temperature of the fuel cell 60 can be reduced. The control unit 10 then terminates execution of the flowchart.

According to the flowchart shown in FIG. 5, the temperature of the fuel cell 60 can be estimated in accordance with the estimated electric resistance R. Further, by increasing or reducing a required load (control amount) of the power generation amount control device 90 to increase or reduce the power generation amount of the of the fuel cell 60 such that the estimated electric resistance R enters a predetermined range, the temperature of the fuel cell 60 can be controlled to a predetermined range. Note that in step S24, the control unit 10 may control the power generation amount control device 90 to increase the power generation amount of the fuel cell 60 further such that the required load increases as the difference between the estimated electric resistance R and the first threshold X increases. Further, in step S26, the control unit 10 may reduce the power generation amount of the fuel cell 60 further by controlling the power generation amount control device 90 such that the required load decreases as the difference between the estimated electric resistance R and the second threshold Y increases. In this case, the time required to control the temperature of the fuel cell 60 can be shortened.

Note that in the flowcharts of FIGS. 3 to 5, a variation width of at least one of the control parameters (the oxidant gas supply amount, the fuel gas supply amount, and the power generation amount) may be increased as the momentary current I_t of the fuel cell 60 increases. The reason for this is that the estimated electric resistance R decreases as the momentary current I_t increases, and therefore temperature variation in the fuel cell 60 increases due to slight electric resistance variation.

Further, the electric resistance of the fuel cell 60 may be estimated using a method other than the calculation shown in Equation (1). For example, the estimated electric resistance R may be estimated on the basis of a voltage value relative to the power generation current of the fuel cell 60 or a current value relative to a power generation voltage value of the fuel cell 60. The estimated electric resistance R may also be estimated on the basis of an incline of a current-voltage characteristic of the fuel cell 60. For example, an absolute value of a variation amount ΔV/ΔI generated either by varying the current or the voltage intentionally or before and after a load variation may be set as the estimated electric resistance R.

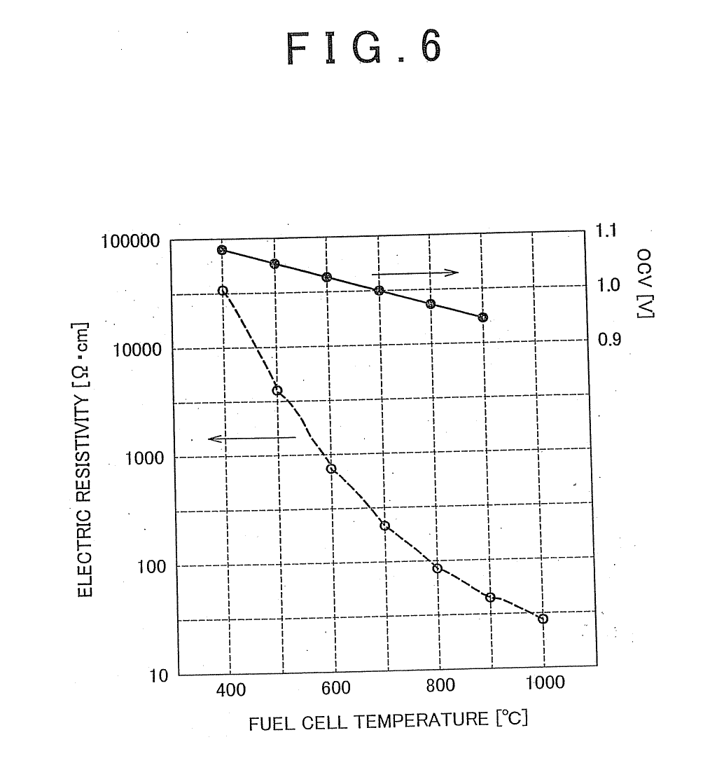

Furthermore, the electric resistance may be estimated from the voltage (the open circuit voltage OCV) when the power generation current of the fuel cell 60 is zero. FIG. 6 is a view illustrating a relationship between the temperature of the fuel cell 60 and the open circuit voltage OCV. In FIG. 6, the ordinate on the left side shows the open circuit voltage.

As shown by a solid line in FIG. 6, the open circuit voltage OCV decreases similarly to the electric resistivity of the fuel cell, shown by a broken line, as the temperature of the fuel cell 60 increases. Therefore, the temperature and the electric resistivity of the fuel cell 60 can be estimated by detecting the open circuit voltage OCV.

Note that the fuel cell 60 may be a single cell constituted by a single fuel cell unit or a fuel cell stack formed by laminating a plurality of fuel cell units via collecting members. In the case of a fuel cell stack, the voltage of the fuel cell 60 may be detected by detecting the voltage of any one fuel cell unit, detecting the respective voltages of the plurality of fuel cell units, detecting the voltage of a laminated body constituted by a plurality of fuel cell units, or detecting an overall voltage of the fuel cell stack. Furthermore, in this embodiment, the current output by the fuel cell 60 during power generation is employed as an electricity amount required to estimate the estimated electric resistance R, but the voltage output during power generation or a power output during power generation may be employed instead.

Further, the control unit 10 may set the target electric resistance range at a steadily higher electric resistance range (a lower temperature range) as the current detected by the ammeter 71 decreases. In this case, the durability of the fuel cell 60 during a long continuous operation at a low load improves.

According to this embodiment, the temperature of the fuel cell 60 can be controlled by estimating the electric resistance using simple devices such as an ammeter and a voltmeter, without using a temperature sensor. As a result, a reduction in cost can be achieved. Further, the temperature of the entire fuel cell 60 (in a case where the fuel cell 60 is a fuel cell stack constituted by laminated bodies of a plurality of fuel cell units, the entirety of a laminated body forming a part of the fuel cell stack or the entire fuel cell stack) can be estimated instead of using a temperature sensor to detect a narrow temperature range, and therefore the effects of local temperature variation can be eliminated.

Note that in this embodiment, the control unit 10 functions as estimating means and setting means. Further, the control unit 10 and raw fuel supply unit 20, the control unit 10 and oxidant gas supply unit 40, or the control unit 10 and power generation amount control device 90 function as temperature controlling means.

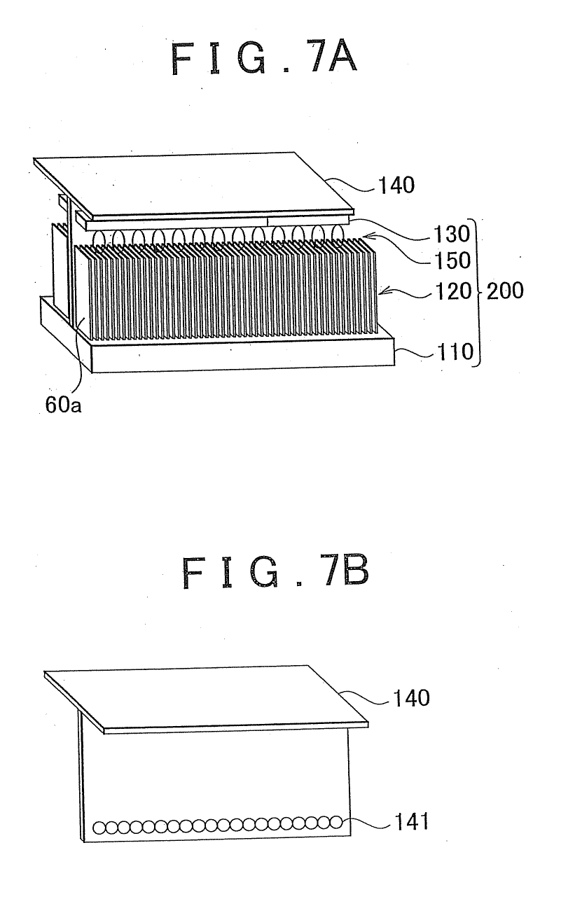

Temperature control in a fuel cell stack device including fuel cell stacks (fuel cells) formed by laminating a plurality of fuel cell units via collecting members will now be described as a second embodiment of the invention. A fuel cell stack device 200 according to this embodiment will be described below with reference to FIGS. 7 to 10. FIG. 7A is a perspective view showing the fuel cell stack device 200 and an oxidant gas introduction member 140 for introducing oxidant gas into the fuel cell stack device 200, and FIG. 7B is a perspective view showing the oxidant gas introduction member 140 in an extracted state. As shown in FIG. 7A, in the fuel cell stack device 200, two fuel cell stacks 120 (the fuel cell 60) are disposed in series on a manifold 110 such that respective lamination directions thereof are substantially parallel. The fuel cell stacks 120 are structured by laminating a plurality of solid oxide fuel cell units 60a.

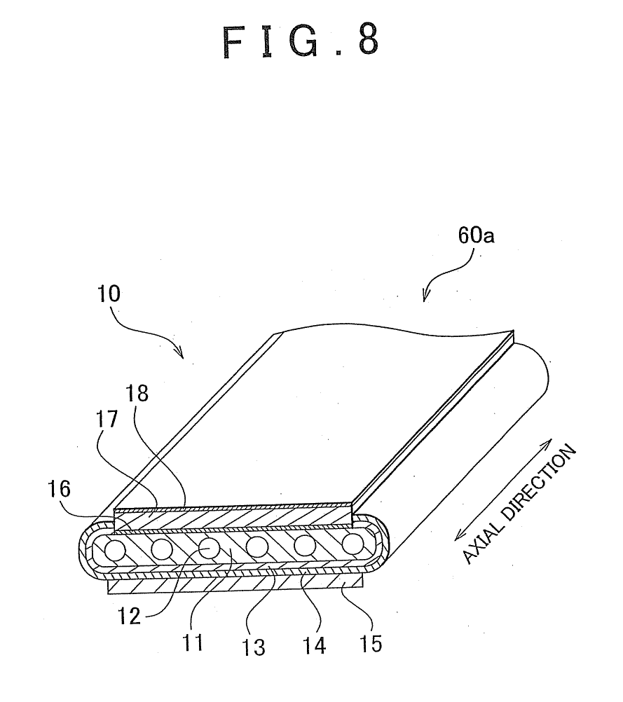

FIG. 8 is a partial perspective view including a cross-section of the fuel cell unit 60a. As shown in FIG. 8, the fuel cell unit 60a takes a columnar flat plate overall shape. A plurality of fuel gas passages 12 penetrating in an axial direction (lengthwise direction) are formed in the interior of a conductive support body 11 possessing gas permeability. A fuel electrode 13, a solid electrolyte 14, and an oxygen electrode 15 are laminated in sequence on one plane of an outer peripheral surface of the conductive support body 11. An interconnector 17 is provided on another plane opposing the oxygen electrode 15 via a joining layer 16, and a contact resistance-reducing P type semiconductor layer 18 is provided thereon.

By supplying a reformed gas containing hydrogen to the fuel gas passages 12, hydrogen is supplied to the fuel electrode 13. By supplying an oxidant gas containing oxygen to the periphery of the fuel cell units 60a, meanwhile, oxygen is supplied to the oxygen electrode 15. Accordingly, electrode reactions shown by following reaction equations (2) and (3) are generated in the oxygen electrode 15 and fuel electrode 13, whereby power is generated. The power generation reaction is performed at 600° C. to 1000° C., for example.

Oxygen electrode: ½O₂+2e⁻→O²⁻(solid electrolyte) (2)

Fuel electrode: O²⁻(solid electrolyte)+H₂→H₂O+2e⁻ (3)

The material of the oxygen electrode 15 is resistant to oxidation and has a porous property to ensure that gas phase oxygen can reach an interface with the solid electrolyte 14. The solid electrolyte 14 functions to move oxygen ions O²⁻ from the oxygen electrode 15 to the fuel electrode 13. The solid electrolyte 14 is constituted by an oxygen ion conducting oxide. Further, the solid electrolyte 14 possesses stability and density in an oxidizing/reducing atmosphere in order to separate the fuel gas from the oxidant gas physically. The fuel electrode 13 is constituted by a material possessing stability and hydrogen affinity in a reducing atmosphere. The interconnector 17 is provided to connect the fuel cell units 60a electrically to each other in series, and is sufficiently dense to separate the fuel gas from the oxidant gas physically.

The oxygen electrode 15 may be formed from a lanthanum cobaltite based perovskite type compound oxide that is highly conductive with respect to both electrons and ions, for example. The solid electrolyte 14 may be formed from ZrO₂ containing highly ion-conductive Y₂O₃ (YSZ), for example. The fuel electrode 13 may be formed from a mixture of highly electron-conductive Ni and ZrO₂ containing Y₂O₃ (YSZ), for example. The interconnector 17 may be formed from highly electron-conductive LaCrO₃ constituted by a solid solution of an alkaline earth oxide, for example. Respective thermal expansion coefficients of these materials may be close to each other.

Holes that communicate with the fuel gas passages 12 of the respective fuel cell units 60a are formed in the manifold 110 shown in FIG. 7A. Thus, the fuel gas that flows through the manifold 110 is introduced into the fuel gas passages 12. A reformer 130 is disposed on the opposite side of the manifold 110 to the fuel cell stacks 120. For example, the reformer 130 is structured to extend in a lamination direction of one of the fuel cell stacks 120, bend back at one end side, and then extend in the lamination direction of the other fuel cell stack 120.

Further, as shown in FIG. 7B, an oxidant gas introduction member 140 is disposed between the fuel cell stacks 120. A space through which the oxidant gas flows is formed in the oxidant gas introduction member 140. Holes are formed in a manifold 110 side end portion of the oxidant gas introduction member 140. Thus, the oxidant gas flows along an outer side of each fuel cell unit 60a. By causing the fuel gas to flow through the fuel gas passages 12 of the fuel cell units 60a and causing the oxidant gas to flow along the outer sides of the fuel cell units 60a, power generation is performed in the fuel cell units 60a.

After contributing to power generation in the fuel cell units 60a, the fuel gas (fuel off gas) and the oxidant gas (oxidant off gas) converge in an end portion of the respective fuel cell units 60a on the opposite side to the manifold 110. The fuel off gas contains combustible material such as unburned hydrogen, and therefore the fuel off gas is burned using oxygen contained in the oxidant off gas. In this embodiment, a site between the upper end of the fuel cell units 60a (the fuel cell stacks 120) and the reformer 130 in which the fuel off gas is burned will be referred to as a combustion portion 150. Combustion heat from the combustion portion 150 is supplied to the reformer 130 and the fuel cell stacks 120.

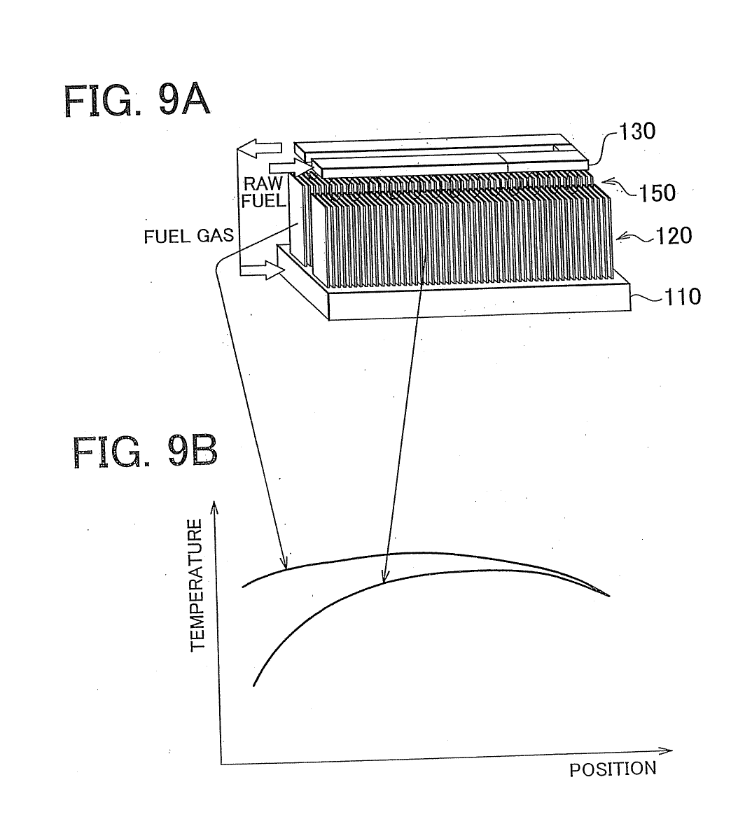

The reformer 130 functions as a vaporization/mixing unit and a reforming unit from an upstream side to a downstream side. As shown in FIG. 9A, when raw fuel such as hydrocarbon and reforming water are supplied to the reformer 130, in the vaporization/mixing unit, the reforming water is vaporized to generate water vapor and the generated water vapor is mixed with the hydrocarbon or other raw fuel. Then, in the reforming unit, a steam reforming reaction is induced between the water vapor and the hydrocarbon or other raw fuel via a catalyst, whereby the fuel gas is generated.

The reforming water absorbs heat when vaporized. Furthermore, the steam reforming reaction is an endothermic reaction. It is therefore easy to generate a large temperature difference in the reformer 130. As a result, a large temperature difference can be generated easily in the fuel cell stacks 120 also. For example, as shown in FIG. 9B, a temperature difference occurs between one fuel cell stack 120 and the other fuel cell stack 120, and a large temperature difference occurs in the respective fuel cell stacks 120 in the lamination direction of the fuel cell units 60a. Hence, when the fuel cell stacks 120 are adjacent to the reformer 130, a large temperature difference can be generated easily in the fuel cell stacks 120. Note that in FIG. 9B, the abscissa shows lamination direction positions of the respective fuel cell units 60a constituting the fuel cell stacks 120 and the ordinate shows temperature.

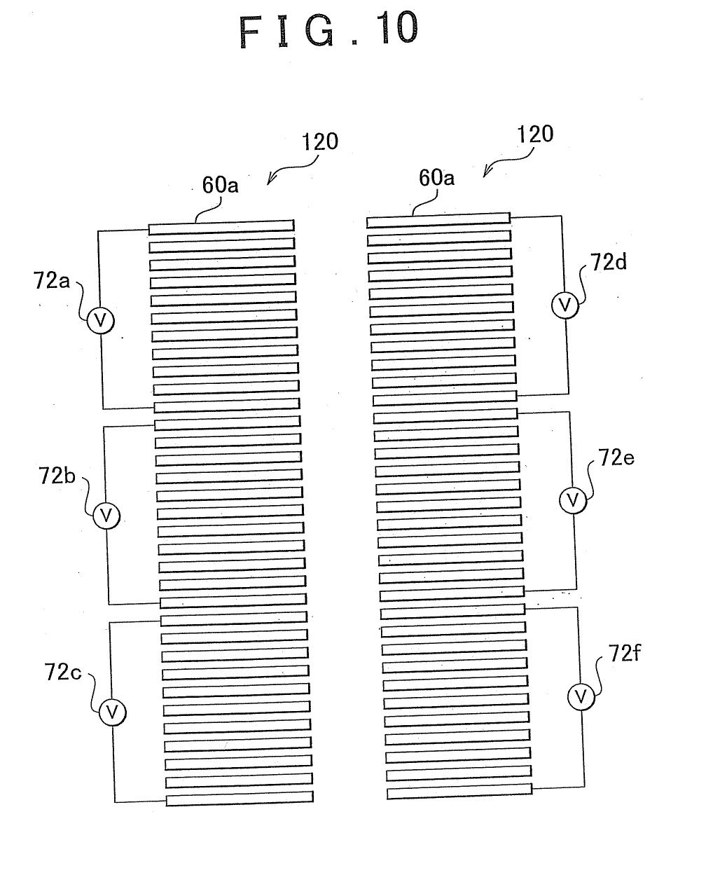

In this embodiment, as shown in FIG. 10, a plurality of voltmeters 72a to 72f is provided. FIG. 10 is a view showing the fuel cell stacks 120 from the reformer 130 side. The voltmeters 72a to 72f detect respective voltages of laminated bodies constituted by a plurality of the fuel cell units 60a. Furthermore, the power generation current (the current output as a result of power generation) of the fuel cell stacks 120 is detected using the ammeter described in the first embodiment. In this case, the electric resistance of each laminated body can be estimated. As a result, the temperature of each laminated body can be estimated.

For example, by detecting the voltage of a laminated body forming a central portion side of the fuel cell stack 120, the temperature of a high temperature portion of the fuel cell stack 120 can be estimated. Further, by detecting the voltage of a laminated body forming an end portion side of the fuel cell stack 120, the temperature of a low temperature portion of the fuel cell stack 120 can be estimated. Hence, the temperature of the fuel cell stack 120 can be controlled on the basis of the estimated temperature of a location in which temperature control is to be prioritized. The temperature of the fuel cell stack 120 may be controlled by increasing or decreasing the amount of raw fuel supplied to the reformer 130, the amount of oxidant gas supplied to the fuel cell stack 120, or the load of the fuel cell stack 120, as described in the first embodiment.

Note that the embodiments described above are applicable to any type of fuel cell, such as a solid polymer fuel cell, an SOFC, or a molten carbonate fuel cell. However, particularly favorable effects are obtained in a high temperature type fuel cell such as an SOFC, in which temperature detection is difficult.

While some embodiments of the invention have been illustrated above, it is to be understood that the invention is not limited to details of the illustrated embodiments, but may be embodied with various changes, modifications or improvements, which may occur to those skilled in the art, without departing from the scope of the invention.

1. A fuel cell system comprising:
a fuel cell that generates power using an oxidant gas and a fuel gas;
an estimating portion that estimates an electric resistance of the fuel cell in accordance with a voltage and a current output by the fuel cell; and
a temperature controlling portion that performs temperature control to raise a temperature of the fuel cell when the electric resistance estimated by the estimating portion exceeds a target electric resistance range and reduce the temperature of the fuel cell when the estimated electric resistance falls below the target electric resistance range.

2. The fuel cell system according to claim 1, wherein the temperature control is control for raising the temperature of the fuel cell by a steadily greater amount as a difference between the estimated electric resistance and an upper limit of the target electric resistance range increases and reducing the temperature of the fuel cell by a steadily greater amount as a difference between the estimated electric resistance and a lower limit of the target electric resistance range increases.

3. The fuel cell system according to claim 1, wherein the temperature controlling portion varies the temperature of the fuel cell by a steadily greater amount as the current that is output by the fuel cell increases.

4. The fuel cell system according to claim 1, wherein the estimating means portion estimates the electric resistance in accordance with an incline of a current-voltage characteristic that the fuel cell has.

5. The fuel cell system according to claim 1, wherein the estimating means portion estimates the electric resistance on the basis of a value of the voltage relative to the current output by the fuel cell or a value of the current relative to the voltage output by the fuel cell.

6. The fuel cell system according to claim 1, wherein the estimating means portion estimates the electric resistance on the basis of an open circuit voltage value that the fuel cell has or a value determined using the open circuit voltage.

7. The fuel cell system according to claim 1, wherein the temperature controlling portion varies the temperature of the fuel cell by increasing or decreasing a supply amount of the oxidant gas supplied to the fuel cell.

8. The fuel cell system according to claim 1, wherein the temperature controlling portion varies the temperature of the fuel cell by increasing or decreasing a power generation amount of the fuel cell.

9. The fuel cell system according to claim 1, wherein the temperature controlling portion varies the temperature of the fuel cell by increasing or decreasing a supply amount of the fuel gas supplied to the fuel cell.

10. The fuel cell system according to claim 1, further comprising a reformer for generating the fuel gas from a hydrocarbon based fuel and supplying the fuel gas to the fuel cell,
wherein the temperature controlling portion varies the temperature of the fuel cell by increasing or decreasing a supply amount of the hydrocarbon based fuel supplied to the reformer, and
the fuel gas contains hydrogen.

11. The fuel cell system according to claim 1, further comprising a setting portion that sets the target electric resistance range,
wherein the setting portion sets the target electric resistance range at a steadily higher value as the current of the fuel cell decreases.

12. The fuel cell system according to claim 1, wherein the fuel cell is a solid oxide fuel cell.

13. An operating method for a fuel cell system, comprising:
estimating an electric resistance of a fuel cell in accordance with a voltage and a current output by the fuel cell; and
performing temperature control to raise a temperature of the fuel cell when the estimated electric resistance exceeds a target electric resistance range and reduce the temperature of the fuel cell when the estimated electric resistance falls below the target electric resistance range.

14. The operating method according to claim 13, wherein the temperature control is control for raising the temperature of the fuel cell by a steadily greater amount as a difference between the estimated electric resistance and an upper limit of the target electric resistance range increases and reducing the temperature of the fuel cell by a steadily greater amount as a difference between the estimated electric resistance and a lower limit of the target electric resistance range increases.

15. The operating method according to claim 13, wherein the control is control for varying the temperature of the fuel cell by a steadily greater amount as the current that is output by the fuel cell increases.

16. The operating method according to claim 13, wherein the electric resistance is estimated in accordance with an incline of a current-voltage characteristic that the fuel cell has.

17. The operating method according to claim 13, wherein the electric resistance is estimated on the basis of a value of the voltage relative to the current output by the fuel cell or a value of the current relative to the voltage output by the fuel cell.

18. The operating method according to claim 13, wherein the electric resistance is estimated on the basis of an open circuit voltage value that the fuel cell has or a value determined using the open circuit voltage.

19. The operating method according to claim 13, wherein the temperature control is control for varying the temperature of the fuel cell by increasing or decreasing a supply amount of an oxidant gas supplied to the fuel cell.

20. The operating method according to claim 13, wherein the temperature control is control for varying the temperature of the fuel cell by increasing or decreasing a power generation amount of the fuel cell.

21. The operating method according to claim 13, wherein the temperature control is control for varying the temperature of the fuel cell by increasing or decreasing a supply amount of a fuel gas supplied to the fuel cell.

22. The operating method according to claim 13, wherein the temperature control is control for varying the temperature of the fuel cell by increasing or decreasing a supply amount of a hydrocarbon based fuel that is supplied to a reformer for generating a fuel gas containing hydrogen from the hydrocarbon based fuel and supplying the fuel gas to the fuel cell.

23. The operating method according to claim 13, further comprising setting the target electric resistance range at a steadily higher value as the current of the fuel cell decreases.

24. The operating method according to claim 13, wherein the fuel cell is a solid oxide fuel cell.
